(19) United States
(12) Patent Application Publication
(10) Pub. No.: US 2015/0266272 A1
(43) Pub. Date: Sep. 24, 2015

(54) FLEXIBLE DISPLAY DEVICE AND METHOD OF MANUFACTURING THE SAME

(71) Applicant: SAMSUNG DISPLAY CO., LTD., Yongin-City (KR)

(72) Inventors: Kyu-taek LEE, Cheonan-si (KR); Kyu Young KIM, Suwon-si (KR); SeungWook NAM, Cheonan-si (KR); Taehyeog JUNG, Hwaseong-si (KR)

(21) Appl. No.: 14/620,737

(22) Filed: Feb. 12, 2015

(30) Foreign Application Priority Data
Mar. 18, 2014 (KR) 10-2014-0031717

(51) Int. Cl. B32B 17/06; B32B 37/24; B32B 37/12; B32B 7/12

(52) U.S. Cl. CPC B32B 17/064; B32B 7/12; B32B 37/24; B32B 37/1284; B32B 2457/20; B32B 2307/546; B32B 2307/42; B32B 2037/243

(57) ABSTRACT

A flexible display device may include a flexible display panel and a window member. The window member may include a synthetic resin layer disposed on the surface of the flexible display panel and a glass layer disposed on the synthetic resin layer. The glass layer may have a thickness of about 25 micrometers to about 100 micrometers. The synthetic resin layer may be formed by coating a synthetic resin solution on a surface of the glass layer.

### CROSS-REFERENCE TO RELATED APPLICATION

Korean Patent Application No. 10-2014-0031717, filed on Mar. 18, 2014, in the Korean Intellectual Property Office, and entitled: “Flexible Display Device And Method Of Manufacturing The Same,” is incorporated by reference herein in its entirety.

### BACKGROUND

1. Field

The present disclosure relates to a flexible display device and a method of manufacturing the same.

2. Description of the Related Art

Curved display devices and foldable or bendable display devices, i.e., flexible display devices, have been developed. The flexible display devices may include a flexible display panel and various functional members.

The functional members may be disposed on at least one surface of both surfaces of the flexible display panel. The functional members may be curved and bent together with the flexible display panel.

### SUMMARY

According to exemplary embodiments a flexible display device may include a flexible display panel and a window member on a surface of the flexible display panel. The window member may include a synthetic resin layer on the surface of the flexible display panel and a glass layer on the synthetic resin layer. The glass layer may have a thickness ranging from about 25 micrometers to about 100 micrometers.

The window member may have a thickness ranging from about 50 micrometers to about 300 micrometers.

The synthetic resin layer may be directly coupled to the glass layer.

The flexible display device may further include an adhesive layer between the synthetic resin layer and the glass layer to couple the synthetic resin layer and the glass layer.

The glass layer may include aluminosilicate-based glass.

The flexible display device may further include a functional coating layer on the glass layer.

The functional coating layer may include at least one of an anti-fingerprint coating layer, an anti-reflection coating layer, an anti-glare coating layer, and a hard coating layer.

The flexible display device may further include a touch screen and a polarizing plate. The touch screen and the polarizing plate may be between the flexible display panel and the window member.

The flexible display device may further include a pressure sensitive adhesive member between the window member and the flexible display panel to couple the window member and the flexible display panel.

Exemplary embodiments may include a flexible display device including a flexible display panel including a folding area in which a folding axis is defined and a peripheral area adjacent to the folding area, and a window member on a surface of the flexible display panel, the window member overlapping with the folding area and the peripheral area and including a plurality of synthetic resin layers on the surface of the flexible display panel; and a plurality of glass layers alternately arranged with the synthetic resin layers. The glass layer that is an outer surface of the window member may have a thickness ranging from about 25 micrometers to about 100 micrometers.

One synthetic resin layer of the plurality of synthetic resin layers may be directly coupled to one glass layer of the plurality of glass layers.

The flexible display device may further include an adhesive layer between one of the plurality of synthetic resin layers and one of the plurality of glass layers that are adjacent to each other.

Exemplary embodiments may include a method of manufacturing a flexible display device including manufacturing a flexible display panel, manufacturing a window member including a synthetic resin layer and a glass layer, and coupling the flexible display panel and the window member. The manufacturing of the window member may include preparing a glass substrate including a glass layer and forming the synthetic resin layer on the glass substrate.

The forming of the synthetic resin layer may include coating a synthetic resin solution on a surface of the glass substrate to form a coating layer and curing the coating layer.

Curing the coating layer may include curing the coating layer at a temperature of about 100 degrees for about 20 minutes and subsequently curing the coating layer at a temperature of about 300 degrees for about 20 minutes to about 35 minutes.

The forming of the synthetic resin layer may include providing a synthetic resin film to form the synthetic resin layer; forming an adhesive layer on a surface of the glass substrate or a surface of the synthetic resin film, and coupling the glass substrate and the synthetic resin film. The adhesive layer may be between the glass substrate and the synthetic resin film.

### BRIEF DESCRIPTION OF THE DRAWINGS

Features will become apparent to those of ordinary skill in the art by describing in detail exemplary embodiments with reference to the attached drawings in which:

FIG. 1A illustrates a perspective view showing a flexible display device, which is unfolded, according to exemplary embodiments;

FIG. 1B illustrates a side view showing a flexible display device, which is folded, according to exemplary embodiments;

FIG. 2A illustrates a side view showing a window member, which is unfolded, according to exemplary embodiments;

FIG. 2B illustrates a flowchart showing a method of manufacturing a window member according to exemplary embodiments;

FIG. 3A illustrates a side view showing a window member, which is unfolded, according to exemplary embodiments;

FIG. 3B illustrates a flowchart showing a method of manufacturing a window member according to exemplary embodiments;

FIG. 4 illustrates a side view showing a window member, which is unfolded, according to exemplary embodiments; and

FIG. 5 illustrates a side view showing a flexible display device, which is unfolded, according to exemplary embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. In addition, it will also be understood that when a layer is referred to as being “between” two layers, it can be the only layer between the two layers, or one or more intervening layers may also be present. Like reference numerals refer to like elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments will be explained in detail with reference to the accompanying drawings.

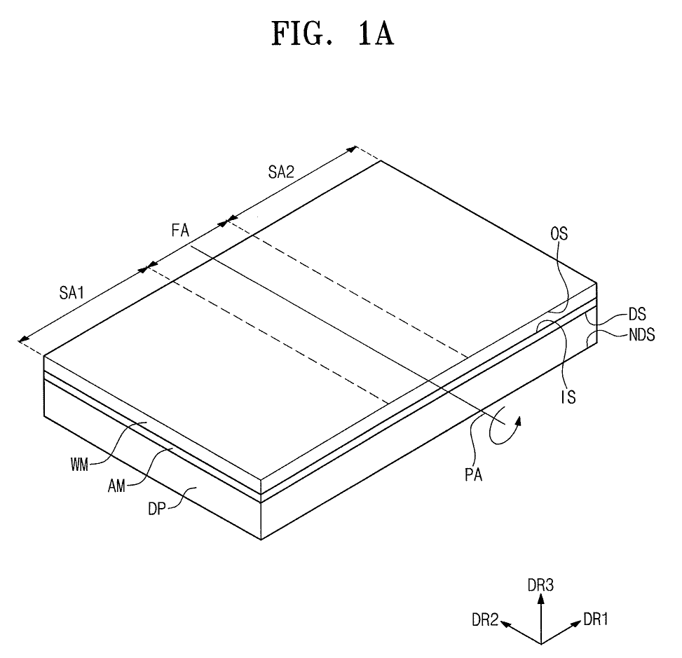

FIG. 1A illustrates a perspective view showing a flexible display device, which is unfolded, according to exemplary embodiments, and FIG. 1B illustrates a side view showing a flexible display device, which is folded, according to exemplary embodiments.

Referring to FIGS. 1A and 1B, a flexible display device (hereinafter, referred to as a display device) may include a flexible display panel DP (hereinafter referred to as a “display panel”) and a flexible window member WM (hereinafter referred to as a “window member”) that may be disposed on a surface of the display panel DP.

The display panel DP may include a flexible base substrate (not shown), signal lines (not shown) disposed on the base substrate, and pixels (not shown) electrically connected to the signal lines. The pixels may generate images in response to signals provided through the signal lines. The display panel DP may be an organic light emitting display panel, an electrophoretic display panel, or an electrowetting display panel.

A surface of the display panel DP, in which the image is displayed, is referred to as a display surface DS and the other surface of the display panel DP, in which no image is displayed, is referred to as a non-display surface NDS. The display panel DP shown in FIGS. 1A and 1B may include one display surface DS, but the number of the display surfaces of the display panel DP is not limited thereto. For example, the display panel DP may include two display surfaces to display the images.

The window member WM may protect the display panel DP. The window member WM may include a transparent material. Although not shown in detail, the window member WM may include a plurality of base layers.

An outer surface OS of the window member WM may serve as an outer surface of the display device. The outer surface of the display device may contact an input device, e.g., a touch pen. An inner surface IS of the window member WM may serve as an adhesive surface and may contact an adhesive member described below.

The display panel DP may be coupled to the window member WM with a transparent adhesive member AM. The adhesive member AM may be an ultraviolet- ray curable pressure-sensitive adhesive sheet. The display panel DP may not be directly coupled to the window member WM. That is, functional members may be further disposed between the display panel DP and the window member WM. The functional members are described in detail below.

The display device may be curved or rolled over an entire area thereof, or bent in a specific area thereof. The display device may include a folding area FA and peripheral areas SA1 and SA2 defined on a plane surface, which is defined by a first direction DR1 and a second direction DR2. FIGS. 1A and 1B show the display device including one folding area FA and two peripheral areas SA1 and SA2 as a representative example.

The display device may be folded in the folding area FA. The display device may be folded along a folding axis PA defined in the folding area FA. The folding axis PA may be an imaginary axis extending in the second direction DR2. The peripheral areas SA1 and SA2 may be disposed adjacent to the folding area FA. The peripheral areas SA1 and SA2 may be flat or slightly curved. The folding area FA and the peripheral areas SAl and SA2 may be defined in the display panel DP and the window member WM.

As shown in FIG. 1B, the display device may be folded to allow the two peripheral areas SA1 and SA2 to face each other. The display device may have a curvature radius R1 of about 0.5 mm to about 10 mm, but is not limited thereto. That is, the display device may be folded to form an included angle of about 10 degrees to about 90 degrees between the two peripheral areas SA1 and SA2.

A thickness T1 in a normal line direction DR3 of the plane surface defined by the first direction DR1 and the second direction DR2 of display device may be substantially the same as a sum of thicknesses of the display panel DP, the window member WM, and the adhesive member AM. As the thickness T1 of the display device increases, tension-compression strain occurring on the display device may increase.

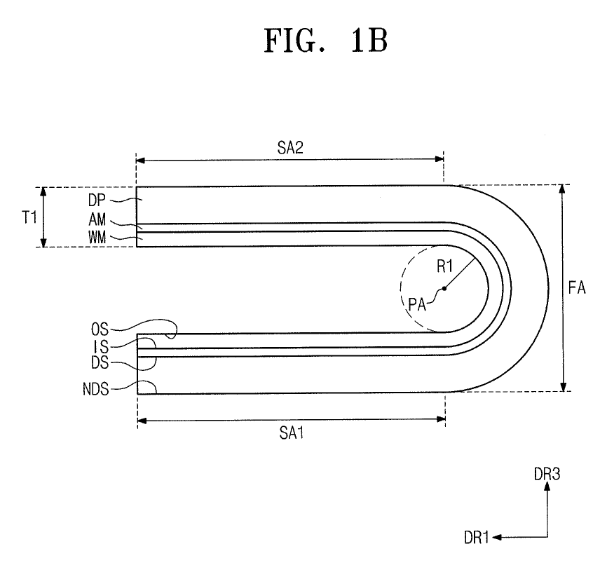

FIG. 2A illustrates a side view showing a window member, which is unfolded, according to exemplary embodiments, and FIG. 2B illustrates a flowchart showing a method of manufacturing a window member according to exemplary embodiments.

Referring to FIG. 2A, the window member WM may include at least one synthetic resin layer PL and at least one glass layer GL. The window member WM shown in FIG. 2A may include one synthetic resin layer PL and one glass layer GL disposed on the synthetic resin layer PL, but the stacking structure of the window member WM is not limited thereto.

The window member WM may have a thickness WT1 of about 50 micrometers to about 300 micrometers. In order to protect the display panel DP from external impacts, the window member WM may have a predetermined stiffness or greater. To this end, the thickness WT1 of the window member WM may be greater than about 50 micrometers. In addition, the thickness WT1 of the window member WM may be smaller than about 300 micrometers, and thus a tension-compression strain proportional to the thickness may be reduced. The thickness WT1 of the window member WM may range from about 50 micrometers to about 300 micrometers according to materials of the synthetic resin layer PL and the glass layer GL.

The synthetic resin layer PL may be directly coupled to the glass layer GL. As described below, the synthetic resin layer PL may be coated on the glass layer GL. Each of the glass layer GL and the synthetic resin layer PL may have a uniform thickness regardless of the areas.

The glass layer GL may include non-alkali glass. The glass layer GL may include aluminosilicate-based glass. The aluminosilicate-based glass may have superior scratch resistance and damage resistance properties.

The glass layer GL may have a thickness WT10 of about 25 micrometers to about 100 micrometers. The stiffness of the window member WM may be determined depending on the glass layer GL having stiffness greater than that of the synthetic resin layer PL. The thickness WT10 of the glass layer GL may be at least about 25 micrometers to allow the window member WM to have the predetermined stiffness. In addition, the thickness WT10 of the glass layer GL may be equal to or smaller than about 100 micrometers because the bending stiffness of the glass layer GL increases as the thickness WT10 of the glass layer GL becomes thicker.

The synthetic resin layer PL may include a transparent plastic. For instance, the transparent plastic may include polyimide (PI), polyethylene naphthalene (PEN), polyisosulfone (PES), polyethylene terephthalate (PET), polyamide (PA), or polycarbonate (PC). The synthetic resin layer PL may have a thickness WT20 of about 25 micrometers to about 200 micrometers.

An upper surface of the glass layer GL may serve as the outer surface OS of the window member WM shown in FIGS. 1A and 1B, and a lower surface of the synthetic resin layer PL may serve as the inner surface IS of the window member WM shown in FIGS. 1A and 1B. Because the glass layer GL may have a stiffness greater than that of the synthetic resin layer PL, damage to the outer surface OS by an input device, e.g., a touch pen, may be reduced or prevented. In addition, the glass layer GL may provide the outer surface OS with a uniform surface roughness.

The window member WM according to exemplary embodiments may be more easily folded in the folding area FA than a glass member having a single layer. This may be because the plural layers have a stiffness smaller than that of the single layer, and the synthetic resin layer PL may have an elastic modulus smaller than that of the glass layer GL.

The bending stiffness of the single layer may be represented by the following equation:

BS∝E×TH³ Equation

In the Equation, “BS” denotes the bending stiffness, “E” denotes the elastic modulus of the single layer, and “TH” denotes the thickness of the single layer.

The bending stiffness of the glass member having the single layer may be proportional to a cube of the thickness of the single layer. The bending stiffness of the layers may be equal to a sum of bending stiffnesses of the layers. The bending stiffness of the window member WM according to exemplary embodiments may be equal to the sum of the bending stiffness of the glass layer GL and the bending stiffness of the synthetic resin layer PL.

In other words, the bending stiffness in the folding area FA of the window member WM may be proportional to a sum of the cube of the thickness WT10 of the glass layer GL and the cube of the thickness WT20 of the synthetic resin layer PL. Accordingly, the window member WM according to the present exemplary embodiment may have a relatively smaller bending stiffness than that of the glass member having the single layer.

The window member WM according to the present exemplary embodiment may have a bending stiffness similar to that of the synthetic resin member having the single layer with the same thickness. This may be because the thickness factor in Equation becomes small in the window member WM due to the double-layer structure of the window member WM even though the glass layer GL may have an elastic modulus greater than that of the synthetic resin member.

Hereinafter, a manufacturing method of the window member WM and the manufacturing method of the flexible display device will be described in detail with reference to FIGS. 2A and 2B.

The flexible display panel DP (refer to FIGS. 1A and 1B) and the window member WM may be manufactured. The flexible display panel DP may be manufactured through photolithography processes and thin film deposition processes. The manufacturing order of the flexible display panel DP and the window member WM is not limited.

To manufacture the window member WM, a glass substrate may be prepared (S10). The glass substrate may correspond to the glass layer GL. A thin glass substrate may be manufactured by reducing a thickness of mother substrate through physical, optical, and/or chemical polishing manners.

A synthetic resin solution may be coated on the window member WM (S20).

The synthetic resin solution may include an organic solvent and a synthetic resin dissolved in the organic solvent. The synthetic resin solution may include about 6 wt % of the synthetic resin. The synthetic resin solution may have a viscosity of about 30,000 cp. The synthetic resin solution may be coated by a slit coater.

The coating layer including the synthetic resin solution may be cured (S30). A first curing process may be performed on the coating layer at a temperature of about 100 degrees and during about 20 minutes. Accordingly, the viscosity of the coating layer may be increased. Then, a second curing process may be performed on the coating layer at a temperature of about 300 degrees and over a time ranging from about 20 minutes to about 35 minutes. Therefore, the glass layer GL may be formed from the coating layer.

The flexible display panel DP and the window member WM may be coupled to each other. The pressure sensitive adhesive member may be attached to the surface of the flexible display panel DP or the surface of the window member WM. The pressure sensitive adhesive member may correspond to the adhesive member AM as shown, for example in FIGS. 1A and 1B. The flexible display panel DP and the window member WM may be coupled to each other such that the pressure sensitive adhesive member is disposed between the flexible display panel DP and the window member WM. Thereafter, the pressure sensitive adhesive member may be cured.

According to the manufacturing method described above, the synthetic resin layer PL may be coupled to the glass layer GL without a separate adhesive member. Thus, the thickness of the window member WM may be decreased and the manufacturing cost of the window member WM may be reduced.

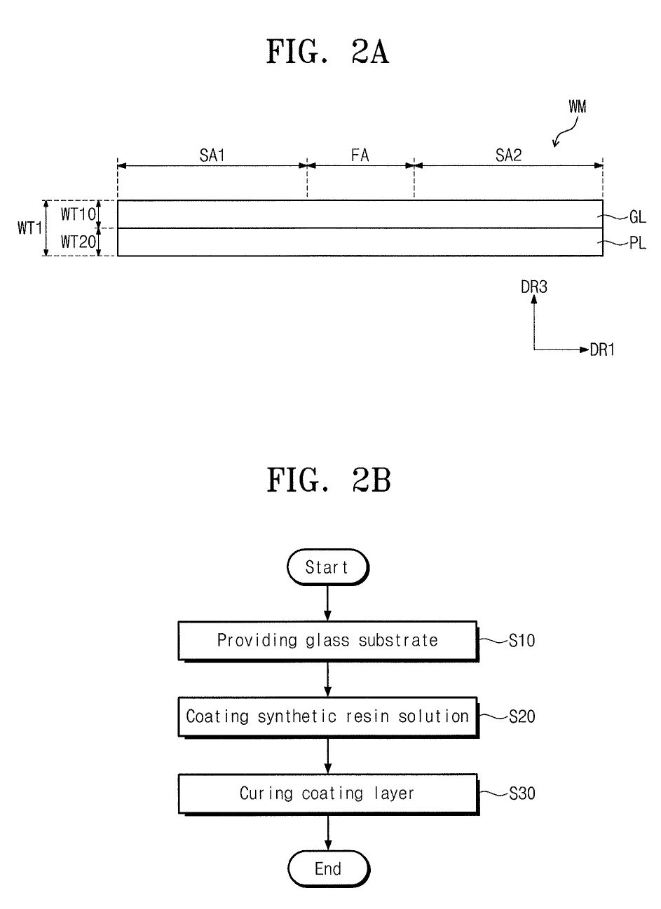

FIG. 3A illustrates a side view showing a window member, which is unfolded, according to exemplary embodiments, and FIG. 3B illustrates a flowchart showing a method of manufacturing a window member according to exemplary embodiments. In FIGS. 3A and 3B, the same reference numerals denote the same elements as in FIGS. 1A to 2B, and thus detailed descriptions of the same elements will be omitted.

Referring to FIG. 3A, the window member WM10 may include at least one synthetic resin layer PL, at least one glass layer GL, and an adhesive layer AL that may couple the synthetic resin layer PL to the glass layer GL. FIG. 3A shows the window member WM 10 having a triple-layer structure as a representative example, but the layer structure of the window member WM10 is not be limited to the triple- layer structure.

The adhesive layer AL may include a pressure sensitive adhesive member or an optically transparent adhesive resin layer. The pressure sensitive adhesive member may include a polymer, a cross-link agent, and/or a resin. The polymer may include at least one of an acryl-based resin, a silicon-base resin, and a urethane-based resin. The optically transparent adhesive resin layer may include at least one of an acryl- based resin and a silicon-based resin.

The adhesive layer AL may have a low elastic modulus to decrease a stress occurring when the window member WM is bent. The elastic modulus of the adhesive layer AL may be equal to or smaller than about 1 MPa. In addition, the adhesive layer AL may have a thickness equal to or smaller than about 50 micrometers.

The following Table 1 represents the bending stiffness of the glass member having a single-layer structure. The following bending stiffness values are measured at a corresponding curvature radius when the glass member having the single-layer structure is bent.

TABLE 1

| | Thickness: | Thickness: |
|---|---|---|
| | 50 micrometers | 30 micrometers |
| Curvature radius: 5 mm | 2.1 N | 0.5 N |
| Curvature radius: 3 mm | 5.7 N | 1.3 N |
| Curvature radius: 1 mm | Cracked | 9.5 N |

The bending stiffness of the glass member having the single-layer structure may increase as the thickness is increased and the curvature radius is decreased. For glass members having the same thickness and the same curvature radius, the bending stiffness decreases as the surface roughness of the glass member decreases. Although not shown separately, when the surface roughness of the glass member is controlled, the glass member having a thickness of about 100 micrometers may not be cracked even though the curvature radius is about 10 mm.

The following Table 2 represents the bending stiffness of the window member WM10 according to exemplary embodiments.

TABLE 2

| | Thickness of glass layer: 25 μm, |
|---|---|
| | thickness of adhesive layer: 25 μm, |
| | thickness of synthetic resin layer: 50 μm |
| Curvature radius: 5 mm | 0.2 N |
| Curvature radius: 3 mm | 0.42 N |
| Curvature radius: 1 mm | 2.2 N |

Although the window member WM10 has a thickness greater than that of the glass member having the single-layer structure, the window member WM10 has a bending stiffness that is less than that of the glass member. The bending stiffness of the window member WM10 may be determined by the glass layer GL having an elastic modulus greater than that of the adhesive layer AL or the synthetic resin layer PL. Because the thickness of the glass layer GL is about 25 micrometers when the thickness of the window member WM10 is about 100 micrometers, the window member WM10 may have a lesser bending stiffness.

Hereinafter, the manufacturing method of the window member WM10 and the manufacturing method of the flexible display device including the window member WM10 will be described in detail with reference to FIGS. 3A and 3B.

The flexible display panel DP (refer to FIGS. 1A and 1B) and the window member WM 10 may be manufactured.

To manufacture the window member WM10, a glass substrate and a synthetic resin film may be prepared (S100). The glass substrate may correspond to the glass layer GL and the synthetic resin film may correspond to the synthetic resin layer PL. The synthetic resin film may be manufactured by a conventional compression or an extrusion process.

The adhesive layer AL may be formed on a surface of the glass substrate or a surface of the synthetic resin film (S200). The pressure sensitive adhesive member may be laminated on the surface of the glass substrate or the surface of the synthetic resin film. An optically transparent adhesive resin in a liquid state may be coated on the surface of the glass substrate or the surface of the synthetic resin film to form a coating layer. The coating layer may be pre-cured.

The glass substrate and the synthetic resin film may be coupled to each other (S300). The glass substrate and the synthetic resin film may be coupled to each other such that the adhesive layer AL is disposed between the glass substrate and the synthetic resin film. Then, the adhesive layer AL may be additionally cured.

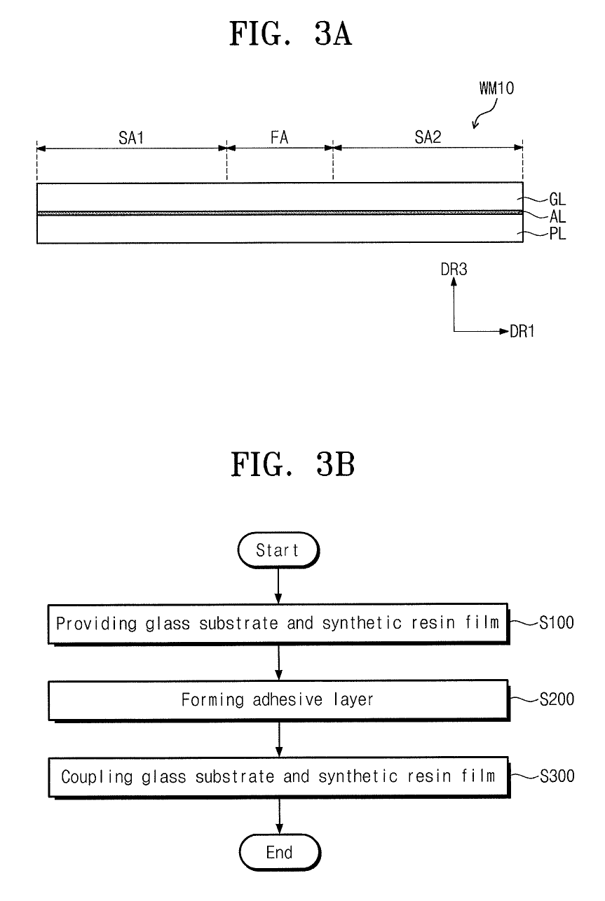

FIG. 4 illustrates a side view showing a window member, which is unfolded, according to exemplary embodiments. In FIG. 4, the same reference numerals denote the same elements in FIGS. 1A to 3B, and thus detailed descriptions of the same elements will be omitted.

Referring to FIG. 4, a window member WM20 may include a plurality of glass layers GL1 and GL2 and a plurality of synthetic resin layers PL1 and PL2. FIG. 4 shows two glass layers GL1 and GL2 and two synthetic resin layers PL1 and PL2 as a representative example.

The glass layers GL1 and GL2 may be alternately arranged with the synthetic resin layers PL1 and PL2. Among the synthetic resin layers PL1 and PL2, a first synthetic resin layer PL1 may be directly coupled to a first glass layer GL1 among the glass layers GL1 and GL2. A second synthetic resin layer PL2 may be directly coupled to a second glass layer GL2. The first synthetic resin layer PL1 may be coupled to the first glass layer GL1 without using the adhesive layer, and the second synthetic resin layer PL2 may be coupled to the second glass layer GL2 without using the adhesive layer.

The window member WM20 may include an adhesive layer to couple one of the glass layers GL1 and GL2 to one of the synthetic resin layers PL1 and PL2. The adhesive layer AL may couple the first synthetic resin layer PL1 to the second glass layer GL2. The adhesive layer AL may include the pressure sensitive adhesive member or the optically transparent adhesive resin layer.

The first synthetic resin layer PL1 may be coupled to the second glass layer GL2 by the method described with reference to FIG. 3B. In this case, the first synthetic resin layer PL1, to which the first glass layer GL1 is coupled, may be coupled to the second glass layer GL2, to which the second synthetic resin layer PL2 may be coupled.

In exemplary embodiments, the window member WM20 may further include an adhesive layer to couple the first glass layer GL1 and the second glass layer GL2 and an adhesive layer to couple the first synthetic resin layer PL1 and the second synthetic resin layer PL2. That is, the adhesive layer AL may be added to or omitted from the window member WM20.

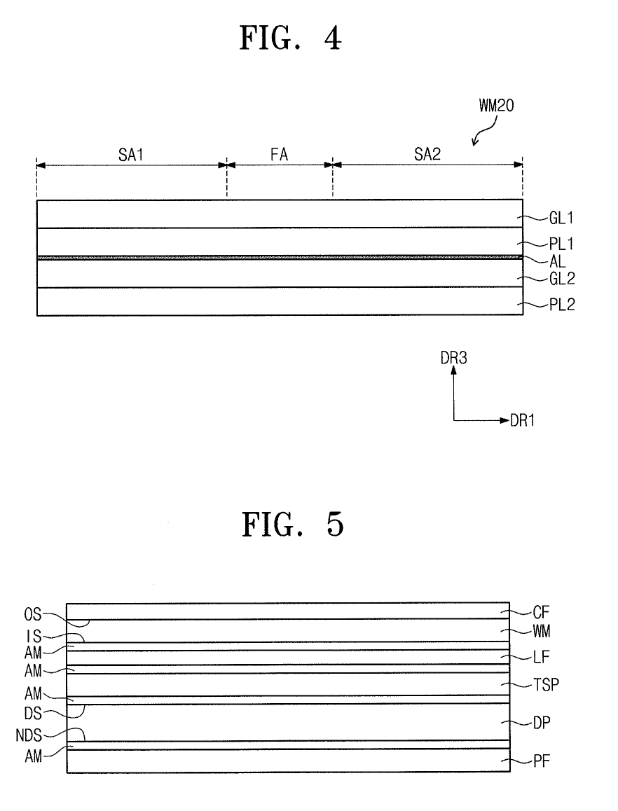

FIG. 5 illustrates a side view showing a flexible display device, which is unfolded, according to exemplary embodiments.

The flexible display device (hereinafter, referred to as a display device) may include a flexible display panel DP (hereinafter, referred to as a display panel), a flexible window member WM (hereinafter, referred to as a window member) disposed on a surface of the display panel DP, and functional members. The window member WM may be one of the window members described with reference to FIGS. lA and 4.

The functional members may include a touch screen TSP and an optical member LF, which may be disposed between the display panel DP and the window member WM. A touch screen that senses external inputs may be coupled to a display screen DS of the display panel DP by an adhesive member AM.

The optical member LF may include at least a polarizing plate, and further may include a retardation plate. The optical member LF may reduce or prevent external light from being reflected. The optical member LF may be coupled to the touch screen TSP by the adhesive member AM. The optical member LF may be omitted or included in the touch screen TSP.

The functional members may further include a protective film PF disposed on a non-display surface NDS of the display panel DP. The protective film PF may protect the display panel DP from external impacts. The protective film PF may be coupled to the display panel DP by the adhesive member AM.

The display device according to the present exemplary embodiment may further include a functional coating layer FC disposed on the outer surface of the window member WM. The functional coating layer FC may include at least one of an anti-fingerprint coating layer, an anti-reflection coating layer, an anti-glare coating layer, and a hard coating layer.

By way of summation and review, a flexible display device according to exemplary embodiments may maintain its durability and may have a reducing bending stiffness. For example, the window member may include the synthetic resin layer and the glass layer. The window member having the double-layer structure may have a bending stiffness less than that of the glass member having the single-layer structure. That is, the window member having the double-layer structure may be more easily folded than the glass member having the single-layer structure.

The outer surface of the window member may be defined by the glass layer. The window member having the double-layer structure and may have a stiffness greater than that of the plastic member having the single-layer structure. As such, damage to the glass layer may be reduced or prevented, and the glass layer may have a uniform surface roughness.

The synthetic resin layer of the window member may be formed by coating the synthetic resin solution on the surface of the glass layer. Thus, the thickness of the window member may be reduced and the manufacturing cost of the flexible display device may be reduced.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A flexible display device comprising:
a flexible display panel; and
a window member on a surface of the flexible display panel, the window member comprising:
a synthetic resin layer on the surface of the flexible display panel; and
a glass layer on the synthetic resin layer,
wherein the glass layer has a thickness ranging from about 25 micrometers to about 100 micrometers.

2. The flexible display device as claimed in claim 1, wherein the window member has a thickness ranging from about 50 micrometers to about 300 micrometers.

3. The flexible display device as claimed in claim 2, wherein the synthetic resin layer is directly coupled to the glass layer.

4. The flexible display device as claimed in claim 2, further comprising an adhesive layer between the synthetic resin layer and the glass layer to couple the synthetic resin layer and the glass layer.

5. The flexible display device as claimed in claim 2, wherein the glass layer includes aluminosilicate-based glass.

6. The flexible display device as claimed in claim 1, further comprising a functional coating layer on the glass layer.

7. The flexible display device as claimed in claim 6, wherein the functional coating layer includes at least one of an anti-fingerprint coating layer, an anti-reflection coating layer, an anti-glare coating layer, and a hard coating layer.

8. The flexible display device as claimed in claim 1, further comprising a touch screen and a polarizing plate,
wherein the touch screen and the polarizing plate are between the flexible display panel and the window member.

9. The flexible display device as claimed in claim 1, further comprising a pressure sensitive adhesive member between the window member and the flexible display panel to couple the window member and the flexible display panel.

10. A flexible display device comprising:
a flexible display panel including a folding area in which a folding axis is defined and a peripheral area adjacent to the folding area; and
a window member on a surface of the flexible display panel, the window member overlapping with the folding area and the peripheral area and including:
a plurality of synthetic resin layers on the surface of the flexible display panel; and
a plurality of glass layers alternately arranged with the synthetic resin layers,
wherein a glass layer that is an outer surface of the window member has a thickness ranging from about 25 micrometers to about 100 micrometers.

11. The flexible display device as claimed in claim 10, wherein one synthetic resin layer of the plurality of synthetic resin layers is directly coupled to one glass layer of the plurality of glass layers.

12. The flexible display device as claimed in claim 10, further comprising an adhesive layer between one of the plurality of synthetic resin layers and one of the plurality of glass layers that are adjacent to each other.

13. A method of manufacturing a flexible display device, comprising:
manufacturing a flexible display panel;
manufacturing a window member including a synthetic resin layer and a glass layer; and
coupling the flexible display panel and the window member, the manufacturing of the window member including:
preparing a glass substrate including the glass layer; and
forming the synthetic resin layer on the glass substrate.

14. The method as claimed in claim 13, wherein the forming of the synthetic resin layer includes:
coating a synthetic resin solution on a surface of the glass substrate to form a coating layer; and
curing the coating layer.

15. The method as claimed in claim 14, wherein the curing of the coating layer includes:
curing the coating layer at a temperature of about 100 degrees for about 20 minutes; and
subsequently curing the coating layer at a temperature of about 300 degrees for about 20 minutes to about 35 minutes.

16. The method as claimed in claim 13, wherein the forming of the synthetic resin layer includes:
providing a synthetic resin film to form the synthetic resin layer;
forming an adhesive layer on a surface of the glass substrate or a surface of the synthetic resin film; and
coupling the glass substrate and the synthetic resin film,
wherein the adhesive layer is between the glass substrate and the synthetic resin film.
